(19) United States
(12) Patent Application Publication
(10) Pub. No.: US 2026/0212797 A1
(43) Pub. Date: Jul. 23, 2026

(54) ELECTRONIC PRICE TAG DISPLAY CONTROL CIRCUIT, AND CONTENT DISPLAY METHOD

(71) Applicant: HEMA (CHINA) CO., LTD., SHANGHAI (CN)

(72) Inventors: Enliang Song, Shanghai (CN); Yimin Wu, Shanghai (CN)

(21) Appl. No.: 19/135,001

(22) PCT Filed: Dec. 4, 2023
(86) PCT No.: PCT/CN2023/136242

§ 371 Date: Jun. 2, 2025

(30) Foreign Application Priority Data
Dec. 6, 2022 (CN) 202211558045.1

(51) Int. Cl. G09G 3/20; G09F 3/20

(52) U.S. Cl. CPC G09G 3/2092; G09F 3/208; G09G 2330/021; G09G 2380/04

(57) ABSTRACT

An electronic price tag display control circuit, comprising: a bridge rectifier circuit and an orientation sensing end, wherein when an electronic price tag is in a first orientation, the bridge rectifier circuit and a guide rail power source are in forward connection, the bridge rectifier circuit and the electronic price tag are in forward connection, and two ends of the orientation sensing end are respectively connected to the bridge rectifier circuit and the electronic price tag; and when the electronic price tag is in a second orientation, the bridge rectifier circuit and the guide rail power source are in reverse connection, the bridge rectifier circuit and the electronic price tag are in forward connection, and the two ends of the orientation sensing end are respectively connected to the bridge rectifier circuit and the electronic price tag.

The present application claims priority to Chinese Patent Application No. 202211558045.1, filed with the China Patent Office on Dec. 6, 2022, and titled “ELECTRONIC PRICE TAG DISPLAY CONTROL CIRCUIT, AND CONTENT DISPLAY METHOD”, which is incorporated herein by reference in its entirety.

### TECHNICAL FIELD

Embodiments of this specification relate to the field of computer technology, and in particular, to a content display method of an electronic price tag. One or more embodiments of this specification also relate to a content display apparatus of an electronic price tag, a computing device, and a computer-readable storage medium.

### BACKGROUND

With the rapid development of the Internet technology, shopping malls and supermarkets are also gradually transforming towards intelligence. At present, many large shopping malls and supermarkets are equipped with electronic price tags to replace traditional paper price tags. Compared with traditional paper price tags, electronic price tags can display more commodity information. When commodity inventory, price and other information fluctuate, an electronic price tag can also adjust the display content in time to ensure that display information is correct. However, when the display information of the electronic price tag needs to be modified, the display content may need to be updated manually by scanning a barcode of the electronic price tag with a gun. When the number of modified electronic price tags is relatively large, a very great workload will be brought to the staff. Therefore, how to quickly update display content of an electronic price tag in a simple and convenient manner is an urgent problem to be solved at present.

### SUMMARY

In view of this, embodiments of this specification provide an electronic price tag display control circuit, and a content display method based on an electronic price tag display control circuit. One or more embodiments of this specification also relate to a content display apparatus based on an electronic price tag display control circuit, a computing device, a computer-readable storage medium, and a computer program, so as to solve the technical defects in the related technologies.

According to a first aspect of the embodiments of this specification, there is provided an electronic price tag display control circuit, the circuit including: a bridge rectifier circuit and an orientation sensing end; wherein with an electronic price tag in a first orientation, the bridge rectifier circuit is in forward connection with a guide rail power source, the bridge rectifier circuit is in forward connection with the electronic price tag, and two ends of the orientation sensing end are respectively connected to the bridge rectifier circuit and the electronic price tag; and wherein with the electronic price tag in a second orientation, the bridge rectifier circuit is in reverse connection with the guide rail power source, the bridge rectifier circuit is in forward connection with the electronic price tag, and the two ends of the orientation sensing end are respectively connected to the bridge rectifier circuit and the electronic price tag.

According to a second aspect of the embodiments of this specification, there is provided a content display method based on an electronic price tag display control circuit, including: acquiring, in response to a power-on instruction, an orientation sensing signal corresponding to an electronic price tag, wherein different orientation sensing signals correspond to different display contents; and determining a target display content corresponding to the orientation sensing signal, and presenting the target display content on the electronic price tag.

According to a third aspect of the embodiments of this specification, there is provided a content display apparatus based on an electronic price tag display control circuit, including: an acquisition module configured to acquire, in response to a power-on instruction, an orientation sensing signal corresponding to an electronic price tag, wherein different orientation sensing signals correspond to different display contents; and a display module configured to determine a target display content corresponding to the orientation sensing signal, and present the target display content on the electronic price tag.

According to a fourth aspect of the embodiments of this specification, there is provided a computing device, including a memory, a processor, and computer instructions stored on the memory and runnable on the processor, wherein the processor, when executing the computer instructions, implements the steps of the content display method based on the electronic price tag display control circuit.

According to a fifth aspect of the embodiments of this specification, there is provided a computer-readable storage medium, which stores computer instructions, wherein the computer instructions, when executed by a processor, implement the steps of the content display method based on the electronic price tag display control circuit.

According to a sixth aspect of the embodiments of this specification, there is provided a computer program, wherein the computer program, when executed in a computer, causes the computer to execute the steps of the content display method based on the electronic price tag display control circuit.

### BRIEF DESCRIPTION OF THE DRAWINGS

In the drawings, unless otherwise specified, the same reference numerals refer to the same or similar parts or elements throughout the drawings. The drawings may not be necessarily drawn to scale. It should be understood that these drawings only depict some implementations disclosed according to the present application, and should not be considered as limiting the scope of the present application.

FIG. 1 shows a schematic diagram of a scenario of an electronic price tag display control circuit provided in an embodiment of this specification.

FIG. 2 shows a circuit structural diagram of an electronic price tag display control circuit provided in an embodiment of this specification.

FIG. 3 shows a structural diagram of a voltage stabilizing circuit of an electronic price tag display control circuit provided in an embodiment of this specification.

FIG. 4 shows a flow chart of a content display method based on an electronic price tag display control circuit provided in an embodiment of this specification.

FIG. 5 shows a flow chart of a processing procedure of a content display method based on an electronic price tag display control circuit provided in an embodiment of this specification.

FIG. 6 shows a schematic structural diagram of a content display apparatus based on an electronic price tag display control circuit provided in an embodiment of this specification.

FIG. 7 shows a structural block diagram of a computing device provided in an embodiment of this specification.

### DETAILED DESCRIPTION

In order to make the objectives, technical solutions and advantages of the present application clearer, the technical solutions of the present application will be clearly and completely described below in conjunction with specific embodiments of the present application and the corresponding drawings. Obviously, the described embodiments are only some of the embodiments of the present application, rather than all of the embodiments. Based on the embodiments in the present application, all other embodiments obtained by those of ordinary skill in the art without making creative labor shall fall within the scope of protection of the present application.

Many specific details will be set forth in the following description to facilitate a thorough understanding of this specification. However, this specification can be implemented in many other manners different from those described here, and those skilled in the art may make similar generalization without departing from the connotation of this specification. Therefore, this specification is not limited by the specific implementations disclosed below.

The terms used in one or more embodiments of this specification are only for the purpose of describing particular embodiments, and are not intended to limit one or more embodiments of this specification. Singular forms of “a/an”, “the” and “this” used in one or more embodiments of this specification and the appended claims are also intended to include plural forms, unless otherwise clearly indicated in the context. It should also be understood that the term “and/or” used in one or more embodiments of this specification refers to any or all possible combinations including one or more associated listed items.

It should be understood that although various information may be described employing terms such as first and second in one or more embodiments of this specification, such information should not be limited by these terms. These terms are only used to distinguish information of the same type from each other. For example, without departing from the scope of one or more embodiments of this specification, a first one may also be referred to as a second one, and similarly, the second one may also be referred to as the first one. Depending on the context, the word “if” as used here may be interpreted as “as” or “when” or “determining . . . in response to . . . ” .

First, nouns and terms involved in one or more embodiments of this specification will be explained.

Electronic price tag is an electronic display apparatus with information sending and receiving functions, which is mainly applied in supermarkets, convenience stores, pharmacies and other electronic tags that display price information. As an electronic display apparatus that is placed on a shelf and may replace a traditional paper price tag, each electronic shelf label can be connected with a computer database of a shopping mall over a wired or wireless network, and displays the latest commodity information through a display screen on the electronic price tag.

Electronic shelf label (ESL), as the digital infrastructure of shopping malls and supermarkets in the retail industry, has been replicated in large quantities in the industry. Electronic price tags are used to replace traditional paper price tags, and price and commodity information of corresponding commodities are displayed to a customer through electronic screens carried on the electronic price tags. In daily use, display content of an electronic price tag often needs to be dynamically changed with the variation of the inventory and selling stage of a commodity or for other reasons. For example, when a certain commodity has been sold out, an electronic price tag should display the information that this commodity has been sold out, so as to avoid the problem that the customer see an electronic price tag without displaying the sellout of the commodity but cannot acquire the commodity, bringing a bad shopping experience to the user. Therefore, by updating display content of an electronic price tag in a timely manner to ensure the accuracy of commodity information, the complaint rate and compliance risk caused by the inconsistency between the display content of the electronic price tag and an actual situation of the commodity can be reduced.

At present, for a change of content display of an electronic price tag, the staff often needs to observe and feel the commodity status or selling stage on the spot, make a human decision to shift the timing of a display content, and perform the change of the display content on the spot. Furthermore, when making adjustment to the display content of the electronic price tag, the staff needs to use a content adjustment tool or reset the display content of the electronic price tag. In the case of using the content adjustment tool, if the staff uses a digital terminal such as a gun/mobile phone to scan electronic price tags in sequence to adjust the display content, such a manner needs the staff to scan and confirm codes for many times, and the operation is complicated. In the case of resetting the display content of the electronic price tag, the staff may need to detach the electronic price tag and set it up for wired connection with a terminal such as a computer, or performs content display settings for each electronic price tag from a back end, but such a way is poor in real-time, and cumbersome in operation, affecting customer shopping experience.

Based on this, there is provided in this specification an electronic price tag display control circuit for quickly and accurately replacing a display content on an electronic price tag; and a content display method based on an electronic price tag display control circuit for enabling an electronic price tag to automatically switch display contents according to different orientation sensing signals. This specification also relates to a content display apparatus based on an electronic price tag display control circuit, a computing device, a computer-readable storage medium, and a computer program, which will be explained in detail in the following embodiments.

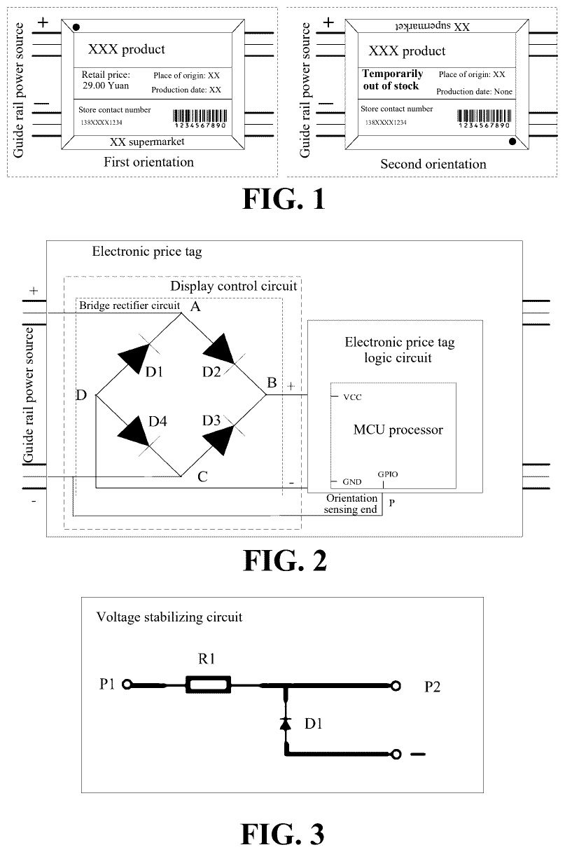

FIG. 1 shows a schematic diagram of a scenario of an electronic price tag display control circuit provided in an embodiment of this specification. FIG. 1 includes display contents of an electronic price tag in two different installation orientations. In a first orientation, the electronic price tag is in a condition of forward installation, and the electronic price tag is in forward connection with a guide rail power source. At this time, an orientation sensing end in the electronic price tag display control circuit can sense a positive voltage of the guide rail power source, take the positive voltage as a forward installation orientation sensing signal, and send the forward installation orientation sensing signal to an electronic price tag logic circuit. Then, a MCU processor of the electronic price tag logic circuit receives a voltage output by a bridge rectifier circuit for power supply, and can determine, based on the orientation sensing signal transmitted from the orientation sensing end and received by a logic input end, a display content corresponding to the forward installation orientation sensing signal, and display the forward installation display content in the first orientation as shown in FIG. 1. When the staff finds that this product has been sold out or removed from the shelf, the electronic price tag only needs to be reversely installed to complete a replacement of the display content. In a second orientation as in FIG. 1, the electronic price tag is in a condition of reverse installation, and the electronic price tag is in reverse connection with the guide rail power source. At this time, the orientation sensing end in the electronic price tag display control circuit can sense a negative voltage of the guide rail power source, take the negative voltage as a reverse installation orientation sensing signal, and send the reverse installation orientation sensing signal to the electronic price tag logic circuit. Then, the MCU processor of the electronic price tag logic circuit can determine a display content corresponding to the reverse installation orientation sensing signal, and display the reverse installation display content in the second orientation as in FIG. 1. The electronic price tag display control circuit provided in this specification can display different contents based on different installation conditions of the electronic price tag. Therefore, when a content of the electronic price tag needs to be replaced, the staff only needs to adjust an installation direction of the electronic price tag to complete a replacement of the content of the electronic price tag, simplifying the updating steps of the display content of the electronic price tag, improving the updating efficiency of the display content, and ensuring the accuracy and timeliness of the display content.

FIG. 2 shows a circuit structural diagram of an electronic price tag display control circuit provided in an embodiment of this specification. This circuit includes a bridge rectifier circuit and an orientation sensing end. With an electronic price tag in a first orientation, the bridge rectifier circuit is in forward connection with a guide rail power source, the bridge rectifier circuit is in forward connection with the electronic price tag, and two ends of the orientation sensing end are respectively connected to the bridge rectifier circuit and the electronic price tag.

In practical applications, the display control circuit can be disposed inside the electronic price tag and connected with an electronic price tag logic circuit. The display control circuit includes a bridge rectifier circuit and an orientation sensing end. A first orientation can be understood as that the electronic price tag is forward installed on a shelf, that is, as shown in FIG. 1, in a case where the electronic price tag is in the first orientation, the bridge rectifier circuit in the display control circuit, at this time, is in forward connection with a guide rail power source; the bridge rectifier circuit is connected with the logic circuit of the electronic price tag for supplying power to the logic circuit of the electronic price tag, so that the electronic price tag can work normally; and two ends of the orientation sensing end are respectively connected to the bridge rectifier circuit and the logic circuit of the electronic price tag, and in the first orientation, the orientation sensing end can input a sensing signal corresponding to the first orientation to a MCU processor in the logic circuit of the electronic price tag, so that the electronic price tag displays a display content corresponding to the first orientation.

With the electronic price tag in a second orientation, the bridge rectifier circuit is in reverse connection with the guide rail power source, the bridge rectifier circuit is in forward connection with the electronic price tag, and the two ends of the orientation sensing end are respectively connected to the bridge rectifier circuit and the electronic price tag.

However, when the display content of the electronic price tag needs to be replaced, it is only necessary to reversely install the electronic price tag on the shelf to make the electronic price tag in a second orientation, that is, as shown in FIG. 2, in a case where the electronic price tag is in the second orientation, the bridge rectifier circuit in the display control circuit, at this time, is in reverse connection with the guide rail power source; the mode of connection of the bridge rectifier circuit with the logic circuit of the electronic price tag is unchanged and remains in forward connection. Because the bridge rectifier circuit can convert input alternating current into direct current for output, regardless of how a polarity of the input voltage varies, the bridge rectifier circuit can output a voltage for the electronic price tag to work. In FIG. 2, the MCU processor in the electronic price tag logic can receive the voltage output by the bridge rectifier circuit for power supply, thereby ensuring the stability and reliability of the electronic price tag. The two ends of the orientation sensing end are still respectively connected to the bridge rectifier circuit and the logic circuit of the electronic price tag, but in the second orientation, the orientation sensing end can input a sensing signal corresponding to the second orientation to the logic circuit of the electronic price tag, so that the electronic price tag displays a display content corresponding to the second orientation.

To sum up, by adjusting an installation orientation of the electronic price tag, the polarity of the input voltage of the bridge rectifier circuit in the display control circuit can be changed, so that the orientation sensing end can sense orientation sensing signals of different polarities, and the characteristics of the bridge rectifier circuit can be utilized to make an output voltage polarity unchanged when the input voltage polarity varies, ensuring that the electronic price tag can work normally no matter in what orientation, and to enable, through signals sent by the orientation sensing end, the electronic price tag to display the display contents corresponding to different orientations, implementing that the display contents of the electronic price tag can be replaced by adjusting the installation orientations of the electronic price tag, so that when a display content replacement needs to be performed for the electronic price tag due to reasons such as sellout and removal of goods, the staff only needs to change the installation orientation of the electronic price tag, improving the display content replacement efficiency, simplifying the processing steps for the staff, and also ensuring the timeliness and accuracy of content display in the electronic price tag at the same time, so as to bring a better shopping experience to a customer.

In an embodiment, in order to ensure that the bridge rectifier circuit can normally supply power to the electronic price tag, the forward connection between the bridge rectifier circuit and the guide rail power source and the forward connection between the bridge rectifier circuit and the electronic price tag include: with the electronic price tag in the first orientation, a positive input end of the bridge rectifier circuit is connected to a positive output end of the guide rail power source, a negative input end of the bridge rectifier circuit is connected to a negative output end of the guide rail power source, a positive output end of the bridge rectifier circuit is connected to a positive power source input end of the electronic price tag, and a negative output end of the bridge rectifier circuit is connected to a negative power source input end of the electronic price tag.

As shown in FIG. 2, the positive input end of the bridge rectifier circuit is point A in FIG. 2, the negative input end of the bridge rectifier circuit is point C in FIG. 2, the positive output end of the guide rail power source can be understood as an end of the guide rail power source outputting a high level, the negative output end of the guide rail power source can be understood as an end of the guide rail power source outputting a low level and connected with the positive output end of the guide rail power source through the positive input end of the bridge rectifier circuit, and the negative input end of the bridge rectifier circuit is connected with the negative output end of the guide rail power source, so that the bridge rectifier circuit can rectify an input voltage input by the guide rail power source and then transmit it to the electronic price tag, ensuring the normal power supply to the electronic price tag.

When the electronic price tag is in the second orientation due to the reverse installation, the mode of connection of the guide rail power source with the bridge rectifier circuit varies at this time includes: with the electronic price tag in the second orientation, the positive input end of the bridge rectifier circuit is connected to the negative output end of the guide rail power source, the negative input end of the bridge rectifier circuit is connected to the positive output end of the guide rail power source, the positive output end of the bridge rectifier circuit is connected to the positive power source input end of the electronic price tag, and the negative output end of the bridge rectifier circuit is connected to the negative power source input end of the electronic price tag.

When the electronic price tag is in the second orientation, the electronic price tag is reversely installed on the guide rail, and then a polarity of the voltage input from the guide rail power source to the electronic price tag varies, and then the original forward connection of the bridge rectifier circuit with the guide rail power source is transformed into a reverse connection. At this time, the positive input end of the bridge rectifier circuit is connected with the negative output end of the guide rail power source, and the negative input end of the bridge rectifier circuit is connected with the positive output end of the guide rail power source. The guide rail power source inputs a low level to the positive input end of the bridge rectifier circuit and a high level to the negative input end of the bridge rectifier circuit. However, due to the circuit characteristics of the bridge rectifier circuit, after rectification, a normal voltage is still output to the logic circuit of the electronic price tag, ensuring that the electronic price tag works normally.

To sum up, when a display content needs to be replaced on the electronic price tag, the staff will replace the display content on the electronic price tag by changing an installation direction of the electronic price tag. However, in order to ensure the normal power supply to the electronic price tag, the bridge rectifier circuit is used to rectify an input voltage with a varied polarity as input by the guide rail power source, and then output the rectified voltage to the electronic price tag.

In practical applications, 4 diodes are used to implement rectification in the bridge rectifier circuit. In an implementation, the bridge rectifier circuit includes: a diode D1, a diode D2, a diode D3, and a diode D4, wherein a cathode of the diode D1 is connected with an anode of the diode D2, a cathode of the diode D2 is connected with a cathode of the diode D3, an anode of the diode D3 is connected with a cathode of the diode D4, and an anode of the diode D4 is connected with an anode of the diode D1.

In an embodiment, taking joints among the diodes as input and output ends of the bridge rectifier circuit includes: a joint between the diode D1 and the diode D2 serves as a positive input end of the bridge rectifier circuit, a joint between the diode D2 and the diode D3 serves as a positive output end of the bridge rectifier circuit, a joint between the diode D3 and the diode D4 serves as a negative input end of the bridge rectifier circuit, and a joint between the diode D4 and the diode DI serves as a negative output end of the bridge rectifier circuit.

Taking FIG. 2 as an example, the joint between the diode D1 and the diode D2 serves as the positive input end of the bridge rectifier circuit, that is, point A is taken as the positive input end of the bridge rectifier circuit; the joint between the diode D2 and the diode D3 serves as the positive output end of the bridge rectifier circuit, that is, point B is taken as the positive output end of the bridge rectifier circuit; the joint between the diode D3 and the diode D4 serves as the negative input end of the bridge rectifier circuit, that is, point C is taken as the negative input end of the bridge rectifier circuit; and the joint between the diode D4 and the diode DI serves as the negative output end of the bridge rectifier circuit, that is, point D is taken as the negative output end of the bridge rectifier circuit.

In an implementable manner, when the positive input end of the bridge rectifier circuit is connected to the positive output end of the guide rail power source, and the negative input end of the bridge rectifier circuit is connected to the negative output end of the guide rail power source, by taking FIG. 2 as an example, an input current loop of the guide rail power source, at this time, is: guide rail power source positive input end-bridge rectifier circuit positive input end point A—diode D2—bridge rectifier circuit positive output end point B—electronic price tag logic circuit—bridge rectifier circuit negative output end point D—diode D4—bridge rectifier circuit negative input end point C—guide rail power source negative output end.

In another implementable manner, when the positive input end of the bridge rectifier circuit is connected to the negative output end of the guide rail power source, and the negative input end of the bridge rectifier circuit is connected to the positive output end of the guide rail power source, an input power source loop of the guide rail power source, at this time, is: guide rail power source negative output end bridge rectifier circuit negative input end point C-diode D3-bridge rectifier circuit positive output end point B-electronic price tag logic circuit-bridge rectifier circuit negative output end point D-diode DI-bridge rectifier circuit positive input end point A-guide rail power source positive output end.

Thus, it can be known that when the polarity of the input voltage of the guide rail power source varies due to a variation of the mode of installation of the electronic price tag, the electronic price tag can receive a normal input voltage in the presence of the bridge rectifier circuit, regardless of how the polarity of the input voltage varies, thereby ensuring the normal working of the electronic price tag.

In order to make the electronic price tag change display contents on the electronic price tag according to different installation directions, it is necessary to receive different orientation sensing signals through the orientation sensing end and send a corresponding orientation sensing signal to the electronic price tag, so that the MCU processor of the electronic price tag can determine a current installation direction of the electronic price tag according to the orientation sensing signal, thereby displaying a display content corresponding to the orientation sensing signal. In an embodiment, the mode of connection of the orientation sensing end includes: an end of the orientation sensing end is connected to a target input end of the bridge rectifier circuit, and the other end of the orientation sensing end is connected to a logic input end of the electronic price tag.

The target input end is an input end of the orientation sensing end connected with the bridge rectifier circuit, and the orientation sensing end may be connected with a positive input end of the bridge rectifier circuit, or may be connected with a negative input end of the orientation sensing end. The other end of the orientation sensing end needs to be connected with the logic input end of the electronic price tag, that is, as in FIG. 2, the orientation sensing end can be connected to the logic input end of the MCU processor in the electronic price tag logic circuit for sending an orientation sensing signal to the electronic price tag, and after the logic input end (GPIO) of the electronic price tag receives the orientation sensing signal, a display content corresponding to this orientation sensing signal can be determined and displayed on a display screen of the electronic price tag.

In practical applications, when the electronic price tag is in the first orientation, regardless of which input end of the bridge rectifier circuit the orientation sensing end is connected to, the orientation sensing end will send an orientation sensing signal corresponding to the first orientation to the logic input end of the electronic price tag. Similarly, when the electronic price tag is in the second orientation, the orientation sensing end will also send an orientation sensing signal corresponding to the second orientation to the logic input end of the electronic price tag. As an example, when the orientation sensing end is connected to the positive input end of the bridge rectifier circuit, it receives a positive voltage of the guide rail power source, and then the positive voltage is taken as an orientation sensing signal corresponding to the first orientation and sent to the MCU processor of the electronic price tag; and when the orientation sensing end is connected to the negative input end of the bridge rectifier circuit, it receives a negative voltage of the guide rail power source, and then the negative voltage is taken as an orientation sensing signal corresponding to the first orientation and sent to the MCU processor of the electronic price tag. Subsequently, only a display logic of the MCU processor of the electronic price tag needs to be adjusted, and then corresponding presentation content can be displayed according to an orientation sensing signal, such as displaying a forward installation display content after receiving the positive voltage, or displaying a positive electrode display content after receiving the negative voltage. Therefore, to change a mode of connection of the orientation sensing end with the bridge rectifier circuit, it is only necessary to adjust the display logic of the MCU processor.

In practical applications, when a voltage of the guide rail power source is inconsistent with a withstand voltage at the logic input end of the MCU processor inside the electronic price tag, a voltage stabilizing circuit can be disposed in the electronic price tag display control circuit for adjusting the voltage output by the guide rail power source to the withstand voltage of the MCU processor. In an embodiment, the circuit further includes a voltage stabilizing circuit, wherein an end of the orientation sensing end is connected to a target input end of the bridge rectifier circuit, the other end of the orientation sensing end is connected to an input end of the voltage stabilizing circuit, and an output end of the voltage stabilizing circuit is connected to the electronic price tag.

As shown in FIG. 3, FIG. 3 is a structural diagram of a voltage stabilizing circuit of an electronic price tag display control circuit provided in an embodiment of this specification, in which an end P1 is an input end of the voltage stabilizing circuit for connecting with an orientation sensing end P. When the orientation sensing end is connected at a positive input end of a bridge rectifier circuit, if a guide rail power source is higher than a maximum voltage that a logic input end of a MCU processor can withstand, it is necessary to stabilize a positive voltage of the guide rail power source to the maximum withstand voltage of the logic input end of the MCU processor, thereby ensuring the normal working of the MCU processor. An output end of the voltage stabilizing circuit is connected to the electronic price tag. In an embodiment, the voltage stabilizing circuit further includes a current limiting resistor R1 and a clamping diode D1. An end of the current limiting resistor RI is connected to the input end of the voltage stabilizing circuit, and the other end is connected to a positive output end P2 of the voltage stabilizing circuit, through which an orientation sensing signal is input to the logic input end of the MCU processor. A cathode of the clamping diode D1 is connected to the positive output end of the voltage stabilizing circuit, and an anode thereof is connected to a negative output end of the voltage stabilizing circuit. The negative output end of the voltage stabilizing circuit is connected to a low-level GND input end of the MCU processor.

Correspondingly, a LDO voltage conversion circuit can also be connected at an output end of the bridge rectifier circuit to provide a corresponding working voltage for the MCU processor, ensuring the normal working of the MCU processor. In an implementation, the output end of the bridge rectifier circuit is connected to an input end of the LDO voltage conversion circuit, and an output end of the LDO voltage conversion circuit is connected to the electronic price tag. In an embodiment, a positive output end of the LDO voltage conversion circuit is connected to a VCC positive input end of the MCU processor, and a negative output end of the LDO voltage conversion circuit is connected to a GND negative input end of the MCU processor, thereby providing a suitable working voltage for the MCU.

In another implementable manner, a display content of the electronic price tag can also be quickly replaced without adjusting a mode of installation of the electronic price tag. In order to enable the orientation sensing end to sense different signals, an orientation sensing signal can be changed by adjusting a polarity of the guide rail power source, thereby implementing a content display replacement for the electronic price tag. The polarity of the guide rail power source can be switched by switching a polarity of a voltage input from the guide rail power source to the bridge rectifier circuit through an external power polarity conversion circuit, which can also achieve the purpose of replacing the display content.

This specification provides an electronic price tag display control circuit, including a bridge rectifier circuit and an orientation sensing end; wherein with an electronic price tag in a first orientation, the bridge rectifier circuit is in forward connection with a guide rail power source, the bridge rectifier circuit is in forward connection with the electronic price tag, and two ends of the orientation sensing end are respectively connected to the bridge rectifier circuit and the electronic price tag; and wherein with the electronic price tag in a second orientation, the bridge rectifier circuit is in reverse connection with the guide rail power source, the bridge rectifier circuit is in forward connection with the electronic price tag, and the two ends of the orientation sensing end are respectively connected to the bridge rectifier circuit and the electronic price tag. It is implemented that, based on the display control circuit, with the electronic price tag in different orientations, by changing a mode of connection of the bridge rectifier circuit in the display control circuit with the guide rail power source, the orientation sensing end is enabled to sense orientation sensing signals of different polarities, and send the orientation sensing signals to the logic circuit of the electronic price tag, thereby enabling the MCU processor in the electronic price tag logic circuit to determine, according to different orientation sensing signals, installation orientations of the electronic price tag and display corresponding contents, achieving the purpose of quickly replacing the display content of the electronic price tag, reducing the steps of manually performing content replacement by the staff, improving the display content replacement efficiency of the electronic price tag, providing accurate display content for a customer in real time, and bringing a better shopping experience to the customer.

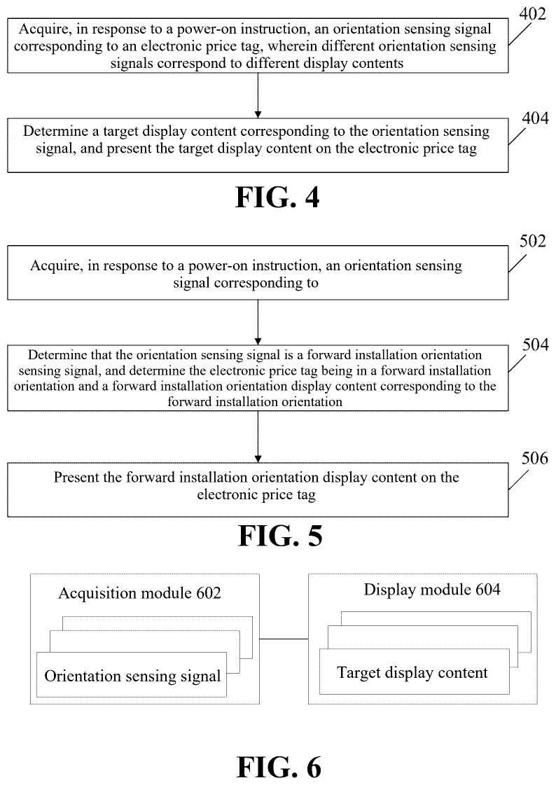

FIG. 4 shows a flow chart of a content display method based on an electronic price tag display control circuit provided in an embodiment of this specification, which includes step 402 to step 404.

At step 402: acquiring, in response to a power-on instruction, an orientation sensing signal corresponding to an electronic price tag, wherein different orientation sensing signals correspond to different display contents.

The power-on instruction can be understood as an instruction to power on the electronic price tag. After the electronic price tag is installed on a guide rail power source, the electronic price tag is powered on and starts to work. At this time, the electronic price tag will acquire an orientation sensing signal at this time. Different orientation sensing signals correspond to different display contents. An orientation sensing signal is used to characterize an installation orientation of the electronic price tag. For example, when the electronic price tag is forward installed, the orientation sensing signal is a forward installation orientation sensing signal, and a display content corresponding to the forward installation orientation sensing signal can be displayed subsequently.

In practical applications, the electronic price tag processes orientation sensing signals by an internal processor, and after an orientation sensing signal is acquired during power-on, a corresponding display content is displayed based on the orientation sensing signal.

In an embodiment of this specification, in response to a power-on instruction, a current orientation sensing signal corresponding to the electronic price tag is acquired, the orientation sensing signal being a forward installation orientation sensing signal.

At step 404: determining a target display content corresponding to the orientation sensing signal, and presenting the target display content on the electronic price tag.

The target display content is a display content corresponding to a current orientation sensing signal. For example, a target display content corresponding to a forward installation orientation sensing signal is a forward installation display content, and a target display content corresponding to a reverse installation orientation sensing signal is a reverse installation display content. In an embodiment, the electronic price tag processes orientation sensing signals by the internal processor, and after a target display content is determined according to an orientation sensing signal, the target display content can be presented on the electronic price tag, which implements that different orientation sensing signals are obtained by adjusting installation modes of the electronic price tag, thereby being able to obtain and present on the electronic price tag corresponding display contents.

In order to enable the electronic price tag to display different display contents in different installation modes, preset display contents can be stored inside the electronic price tag. For example, in a mode of forward installation, price information and the like of a product are displayed normally; and in a mode of reverse installation, information that the product has been sold out and the like are displayed. Therefore, different display contents need to be set according to different orientation sensing signals, and subsequently, different display contents can be determined according to the orientation sensing signals, which includes determining, in a case where the orientation sensing signal is a first orientation sensing signal, the electronic price tag being in a first orientation and a first orientation display content corresponding to the first orientation, and taking the first orientation display content as a target display content; and determining, in a case where the orientation sensing signal is a second orientation sensing signal, the electronic price tag being in a second orientation and a second orientation display content corresponding to the second orientation, and taking the second orientation display content as a target display content.

The first orientation display content can be understood as a display content that should be presented with the electronic price tag in the first orientation, and the second orientation display content can be understood as a display content that should be presented with the electronic price tag in the second orientation. If the electronic price tag is in different orientations, the contents as displayed are also different. In practical applications, the first orientation or the second orientation specifically corresponds to forward installation or reverse installation of the electronic price tag, which can be set according to actual situations. The first orientation may be a forward orientation or a reverse installation orientation; and the second orientation may be a reverse installation orientation or a forward installation orientation. However, it should be noted that corresponding display contents in different orientations need to be set well to avoid errors in which contents are displayed oppositely in different orientations.

In an embodiment of this specification, after an orientation sensing signal is acquired, when the orientation sensing signal is in the first orientation, that is, it is determined that the electronic price tag is in the forward installation orientation, a first orientation display content to be presented in the forward installation orientation is acquired and presented on the electronic price tag.

This specification provides a content display method based on an electronic price tag display control circuit, applied to an electronic price tag, including: acquiring, in response to a power-on instruction, an orientation sensing signal corresponding to the electronic price tag, wherein different orientation sensing signals correspond to different display contents; and determining target display content corresponding to the orientation sensing signal, and presenting the target display content on the electronic price tag. It is implemented that, based on the electronic price tag display control circuit, the electronic price tag acquires an orientation sensing signal after receiving a power-on instruction, determines and displays on the electronic price tag a target display content corresponding to the orientation sensing signal. In this way, the purpose of quickly replacing the display content of the electronic price tag is implemented, so that the staff can complete replacement of content of the electronic price tag without the help of a replacement tool, and the processing efficiency of the staff is improved.

A content display method based on an electronic price tag display control circuit provided in this specification will be further explained below in conjunction with FIG. 5 by taking as an example an application of the content display method based on the electronic price tag display control circuit in a supermarket store. FIG. 5 shows a flow chart of a processing procedure of a content display method based on an electronic price tag display control circuit provided in an embodiment of this specification, and specific steps include step 502 to step 506.

At step 502: acquiring, in response to a power-on instruction, an orientation sensing signal corresponding to an electronic price tag.

In an implementable manner, after the staff forward installs an electronic price tag on a guide rail power source, the electronic price tag is powered on and starts to work to obtain a current orientation sensing signal. The electronic price tag internally includes a display control circuit consisting of a bridge rectifier circuit and an orientation sensing end. When the electronic price tag is in a forward installation orientation, the bridge rectifier circuit is in forward connection with the guide rail power source, the bridge rectifier circuit is in forward connection with a logic circuit of the electronic price tag, and two ends of the orientation sensing end are respectively connected to the bridge rectifier circuit and the logic circuit of the electronic price tag. When the electronic price tag is in a reverse installation orientation, the bridge rectifier circuit is in reverse connection with the guide rail power source, the bridge rectifier circuit is in forward connection with the logic circuit of the electronic price tag, and the two ends of the orientation sensing end are respectively connected to the bridge rectifier circuit and the logic circuit of the electronic price tag.

In an implementation, the forward connection of the bridge rectifier circuit with the guide rail power source can be that a positive input end of the bridge rectifier circuit is connected to a positive output end of the guide rail power source, and a negative input end of the bridge rectifier circuit is connected to a negative output end of the guide rail power source, in which a joint between a diode D4 and a diode Dl in the bridge rectifier circuit is the positive input end of the bridge rectifier circuit, and a joint between a diode D3 and the diode D4 is the negative input end of the bridge rectifier circuit. The reverse connection of the bridge rectifier circuit with the guide rail power source can be that the positive input end of the bridge rectifier circuit is connected to the negative output end of the guide rail power source, and the negative input end of the bridge rectifier circuit is connected to the positive output end of the guide rail power source.

In an embodiment, the forward connection of the bridge rectifier circuit with the electronic price tag can be that a positive output end of the bridge rectifier circuit is connected to a positive power source input end of the electronic price tag, and a negative output end of the bridge rectifier circuit is connected to a negative power source input end of the electronic price tag, in which a joint between a diode D2 and the diode D3 in the bridge rectifier circuit is the positive output end of the bridge rectifier circuit, and a joint between the diode D3 and the diode D4 is the negative output end of the bridge rectifier circuit.

At step 504: determining that the orientation sensing signal is a forward installation orientation sensing signal, and determining the electronic price tag being in a forward installation orientation and a forward installation orientation display content corresponding to the forward installation orientation.

In an implementable manner, the obtained orientation sensing signal is a forward installation orientation sensing signal, and a forward installation orientation display content corresponding to a preset forward installation orientation sensing signal is acquired, the forward installation orientation display content being content such as price information of a product.

In an implementation, an orientation sensing signal can be acquired through a logic input end of the electronic price tag, and processed by a processor in the logic circuit of the electronic price tag to acquire forward installation orientation display content corresponding to this orientation sensing signal, and subsequently an electronic screen can be driven to display the forward installation orientation content.

At step 506: presenting the forward installation orientation display content on the electronic price tag.

In an implementable manner, the forward installation orientation display content is presented on the electronic price tag, so that a display content can be determined according to an installation direction of the electronic price tag.

This specification provides a content display method based on an electronic price tag display control circuit, which implements that an electronic price tag, based on the electronic price tag display control circuit, acquires an orientation sensing signal after receiving a power-on instruction, determines and displays on the electronic price tag a target display content corresponding to the orientation sensing signal, achieving the purpose of quickly replacing the display content of the electronic price tag, reducing the steps of manually performing content replacement by the staff, improving the display content replacement efficiency of the electronic price tag, providing accurate display content for a customer in real time, and bringing a better shopping experience to the customer.

This specification provides an electronic price tag display control circuit, the circuit including: a bridge rectifier circuit and an orientation sensing end; with an electronic price tag in a first orientation, the bridge rectifier circuit is in forward connection with a guide rail power source, the bridge rectifier circuit is in forward connection with the electronic price tag, and two ends of the orientation sensing end are respectively connected to the bridge rectifier circuit and the electronic price tag; and with the electronic price tag in a second orientation, the bridge rectifier circuit is in reverse connection with the guide rail power source, the bridge rectifier circuit is in forward connection with the electronic price tag, and the two ends of the orientation sensing end are respectively connected to the bridge rectifier circuit and the electronic price tag. An embodiment of this specification implements that, based on the display control circuit, with the electronic price tag in different orientations, by changing a mode of connection of the bridge rectifier circuit in the display control circuit with the guide rail power source, the orientation sensing end is enabled to sense different orientations of the electronic price tag, thereby being able to display corresponding contents according to different orientations of the electronic price tag, achieving the purpose of quickly replacing the display content of the electronic price tag, reducing the steps of manually performing content replacement by the staff, improving the display content replacement efficiency of the electronic price tag, providing accurate display content for a customer in real time, and bringing a better shopping experience to the customer.

This specification provides a content display method based on an electronic price tag display control circuit, applied to an electronic price tag, including: acquiring, in response to a power-on instruction, an orientation sensing signal corresponding to the electronic price tag, wherein different orientation sensing signals correspond to different display contents; and determining target display content corresponding to the orientation sensing signal, and presenting the target display content on the electronic price tag. An embodiment of this specification implements that the electronic price tag, based on the electronic price tag display control circuit, acquires an orientation sensing signal after receiving a power-on instruction, determines and displays on the electronic price tag a target display content corresponding to the orientation sensing signal. In this way, the purpose of quickly replacing the display content of the electronic price tag is implemented, so that the staff can complete replacement of content of the electronic price tag without the help of a replacement tool, and the processing efficiency of the staff is improved.

Corresponding to the above method embodiments, this specification further provides an embodiment of a content display method apparatus based on an electronic price tag display control circuit, and FIG. 6 shows a schematic structural diagram of a content display method apparatus based on an electronic price tag display control circuit provided in an embodiment of this specification. As shown in FIG. 6, this apparatus includes: an acquisition module 602 configured to acquire, in response to a power-on instruction, an orientation sensing signal corresponding to an electronic price tag, wherein different orientation sensing signals correspond to different display contents; and a display module 604 configured to determine target display content corresponding to the orientation sensing signal, and present the target display content on the electronic price tag.

In an embodiment, the display module 604 is configured to: determine, in a case where the orientation sensing signal is a first orientation sensing signal, the electronic price tag being in a first orientation and a first orientation display content corresponding to the first orientation, and take the first orientation display content as a target display content; and determine, in a case where the orientation sensing signal is a second orientation sensing signal, the electronic price tag being in a second orientation and a second orientation display content corresponding to the second orientation, and take the second orientation display content as a target display content.

This specification provides a content display apparatus based on an electronic price tag display control circuit, including: an acquisition module configured to acquire, in response to a power-on instruction, an orientation sensing signal corresponding to an electronic price tag, wherein different orientation sensing signals correspond to different display contents; and a display module configured to determine a target display content corresponding to the orientation sensing signal, and present the target display content on the electronic price tag. It is implemented that the electronic price tag, based on an electronic price tag display control circuit, acquires an orientation sensing signal after receiving a power-on instruction, determines and displays on the electronic price tag a target display content corresponding to the orientation sensing signal. In this way, the purpose of quickly replacing the display content of the electronic price tag is implemented, so that the staff can complete replacement of content of the electronic price tag without the help of a replacement tool, and the processing efficiency of the staff is improved.

Described above is a schematic solution of the content display apparatus based on the electronic price tag display control circuit of this embodiment. It should be explained that the technical solution of this content display apparatus based on the electronic price tag display control circuit and the technical solution of the above content display method based on the electronic price tag display control circuit belong to one and the same concept. For details not described in detail in the technical solution of the content display apparatus based on the electronic price tag display control circuit, reference may be made to the description of the technical solution of the above content display method based on the electronic price tag display control circuit.

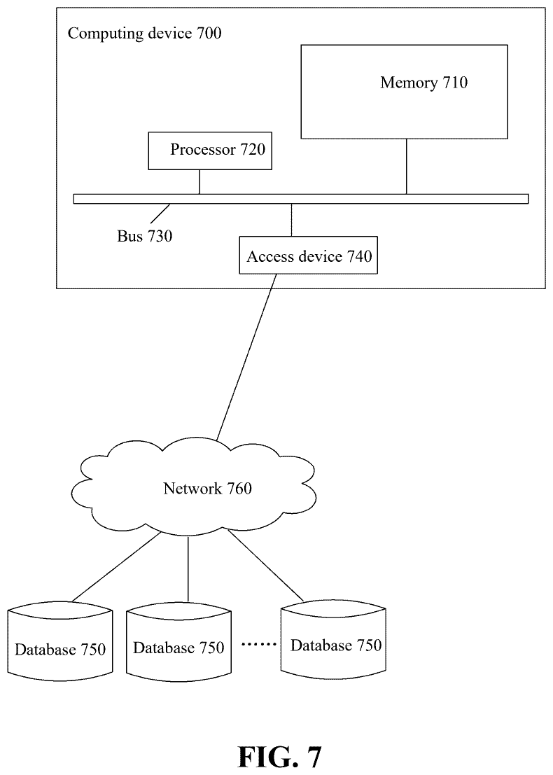

FIG. 7 shows a structural block diagram of a computing device 700 provided in an embodiment of this specification. Parts of this computing device 700 include, but are not limited to, a memory 710 and a processor 720. The processor 720 is connected with the memory 710 through a bus 730, and a database 750 is used to store data.

The computing device 700 further includes an access device 740 that enables the computing device 700 to communicate via one or more networks 760. Examples of these networks include a public switched telephone network (PSTN), a local area network (LAN), a wide area network (WAN), a personal area network (PAN), or a combination of communication networks such as the Internet. The access device 740 may include one or more of any types of wired or wireless network interfaces (e.g., a network interface card (NIC)), such as an IEEE 802.11 wireless local area network (WLAN) wireless interface, a worldwide interoperability for microwave access (Wi-MAX) interface, an Ethernet interface, a universal serial bus (USB) interface, a cellular network interface, a Bluetooth interface, a near field communication (NFC) interface, and the like.

In an embodiment of this specification, the above parts of the computing device 700 and other parts not shown in FIG. 7 may also be connected to each other through, for example, a bus. It should be understood that the structural block diagram of the computing device shown in FIG. 7 is for exemplary purposes only, rather than limiting the scope of this specification. Those skilled in the art can add or replace other parts as needed.

The computing device 700 may be any type of stationary or mobile computing device, including a mobile computer or mobile computing device (e.g., a tablet computer, a personal digital assistant, a laptop computer, a notebook computer, a netbook, etc.), a mobile phone (e.g., a smartphone), a wearable computing device (e.g., a smart watch, smart glasses, etc.), or other types of mobile devices, or a stationary computing device such as a desktop computer or PC. The computing device 700 may also be a mobile or stationary server.

The processor 720, when executing the computer instructions, implements the steps of the content display method based on the electronic price tag display control circuit.

Described above is a schematic solution of the computing device in this embodiment. It should be explained that the technical solution of this computing device and the technical solution of the above content display method based on the electronic price tag display control circuit belong to one and the same concept. For details not described in detail in the technical solution of the computing device, reference may be made to the description of the technical solution of the above content display method based on the electronic price tag display control circuit.

An embodiment of this specification further provides a computer-readable storage medium, which stores computer instructions, wherein the computer instructions, when executed by a processor, implement the steps of the content display method based on the electronic price tag display control circuit as described above.

Described above is a schematic solution of the computer-readable storage medium in this embodiment. It should be explained that the technical solution of this storage medium and the technical solution of the above content display method based on the electronic price tag display control circuit belong to one and the same concept. For details not described in detail in the technical solution of the storage medium, reference may be made to the description of the technical solution of the above content display method based on the electronic price tag display control circuit.

An embodiment of this specification further provides a computer program, wherein the computer program, when executed in a computer, causes the computer to execute the steps of the above content display method based on the electronic price tag display control circuit.

Described above is a schematic solution of the computer program in this embodiment. It should be explained that the technical solution of this computer program and the technical solution of the above content display method based on the electronic price tag display control circuit belong to one and the same concept. For details not described in detail in the technical solution of the computer program, reference may be made to the description of the technical solution of the above content display method based on the electronic price tag display control circuit.

Particular embodiments of this specification have been described above. Other embodiments are within the scope of the appended claims. In some cases, actions or steps recorded in the claims may be executed in a different order from those in the embodiments, and may still achieve desired results. Additionally, processes depicted in the drawings do not necessarily require a particular or consecutive order as shown to achieve desired results. In certain implementations, multitasking and parallel processing are also possible or may be advantageous.

The computer instructions include computer program codes, which may be in a source code form, an object code form, an executable file, or some intermediate forms. The computer-readable medium may include: any entity or apparatus capable of carrying the computer program codes, a recording medium, a USB flash drive, a portable hard drive, a magnetic disc, an optical disc, a computer memory, a read-only memory (ROM), a random-access memory (RAM), an electrical carrier signal, a telecommunications signal, and a software distribution medium. It should be noted that content contained in the computer-readable medium may be appropriately increased or decreased according to the requirements of legislation and patent practice in a jurisdiction. For example, in some jurisdictions, according to legislation and patent practice, a computer-readable medium does not include an electrical carrier signal or a telecommunication signal.

It should be noted that for the convenience of description, the method embodiments described precedingly are all expressed as combinations of a series of actions. However, those skilled in the art should be aware that the embodiments of this specification are not limited by the described action orders, because according to the embodiments of this specification, certain steps may proceed in other sequences or at the same time. Furthermore, those skilled in the art should also be aware that the embodiments described in the specification are all preferred embodiments, and the actions and modules involved are not all definitely necessary for the embodiments of this specification.

In the above embodiments, different focuses are put on their respective descriptions. For parts not detailed in a certain embodiment, reference may be made to the relevant descriptions of other embodiments.

The preferred embodiments of this specification as disclosed above are merely used to help elaborate this specification. The optional embodiments neither exhaustively recite all the details, nor limit the invention to the specific implementations as described. Obviously, according to the content of the embodiments of this specification, many modifications and variations may be conducted. These embodiments are selected and specifically described in this specification in order to better explain the principles and practical applications of the embodiments of this specification, such that those skilled in the art can well understand and utilize this specification. This specification is limited only by the claims and their entire scope and equivalents.

1. An electronic price tag display control circuit, the circuit comprising: a bridge rectifier circuit and an orientation sensing end;
wherein with an electronic price tag in a first orientation, the bridge rectifier circuit is in forward connection with a guide rail power source, the bridge rectifier circuit is in forward connection with the electronic price tag, and two ends of the orientation sensing end are respectively connected to the bridge rectifier circuit and the electronic price tag; and
wherein with the electronic price tag in a second orientation, the bridge rectifier circuit is in reverse connection with the guide rail power source, the bridge rectifier circuit is in forward connection with the electronic price tag, and the two ends of the orientation sensing end are respectively connected to the bridge rectifier circuit and the electronic price tag.

2. The circuit of claim 1, wherein that with the electronic price tag in the first orientation, the bridge rectifier circuit is in forward connection with the guide rail power source, and the bridge rectifier circuit is in forward connection with the electronic price tag, comprises:
with the electronic price tag in the first orientation, a positive input end of the bridge rectifier circuit is connected to a positive output end of the guide rail power source, a negative input end of the bridge rectifier circuit is connected to a negative output end of the guide rail power source, a positive output end of the bridge rectifier circuit is connected to a positive power source input end of the electronic price tag, and a negative output end of the bridge rectifier circuit is connected to a negative power source input end of the electronic price tag.

3. The circuit of claim 1, wherein that with the electronic price tag in the second orientation, the bridge rectifier circuit is in reverse connection with the guide rail power source, and the bridge rectifier circuit is in forward connection with the electronic price tag, comprises:
with the electronic price tag in the second orientation, a positive input end of the bridge rectifier circuit is connected to a negative output end of the guide rail power source, a negative input end of the bridge rectifier circuit is connected to a positive output end of the guide rail power source, a positive output end of the bridge rectifier circuit is connected to a positive power source input end of the electronic price tag, and a negative output end of the bridge rectifier circuit is connected to a negative power source input end of the electronic price tag.

4. The circuit of any one of claim 1, wherein that the two ends of the orientation sensing end are respectively connected to the bridge rectifier circuit and the electronic price tag, comprises:
an end of the orientation sensing end is connected to a target input end of the bridge rectifier circuit, and the other end of the orientation sensing end is connected to a logic input end of the electronic price tag.

5. The circuit of claim 1, wherein the bridge rectifier circuit comprises a diode D1, a diode D2, a diode D3, and a diode D4, and wherein a cathode of the diode D1 is connected with an anode of the diode D2, a cathode of the diode D2 is connected with a cathode of the diode D3, an anode of the diode D3 is connected with a cathode of the diode D4, and an anode of the diode D4 is connected with an anode of the diode D1.

6. The circuit of claim 5, wherein a joint between the diode D1 and the diode D2 serves as a positive input end of the bridge rectifier circuit, a joint between the diode D2 and the diode D3 serves as a positive output end of the bridge rectifier circuit, a joint between the diode D3 and the diode D4 serves as a negative input end of the bridge rectifier circuit, and a joint between the diode D4 and the diode D1 serves as a negative output end of the bridge rectifier circuit.

7. The circuit of claim 1, further comprising a voltage stabilizing circuit, wherein an end of the orientation sensing end is connected to a target input end of the bridge rectifier circuit, the other end of the orientation sensing end is connected to an input end of the voltage stabilizing circuit, and an output end of the voltage stabilizing circuit is connected to the electronic price tag.

8. The circuit of claim 7, wherein the voltage stabilizing circuit comprises a current limiting resistor and a clamping diode, and wherein an end of the current limiting resistor is connected to the input end of the voltage stabilizing circuit, the other end of the current limiting resistor is connected to a positive output end of the voltage stabilizing circuit, a cathode of the clamping diode is connected to the positive output end of the voltage stabilizing circuit, and an anode of the clamping diode is connected to a negative output end of the voltage stabilizing circuit.

9. A content display method based on an electronic price tag display control circuit, applied to an electronic price tag, comprising:
acquiring, in response to a power-on instruction, an orientation sensing signal corresponding to the electronic price tag, wherein different orientation sensing signals correspond to different display contents; and
determining a target display content corresponding to the orientation sensing signal, and presenting the target display content on the electronic price tag.

10. The method of claim 9, wherein determining the target display content corresponding to the orientation sensing signal comprises:
determining, in a case where the orientation sensing signal is a first orientation sensing signal, the electronic price tag being in a first orientation and a first orientation display content corresponding to the first orientation, and taking the first orientation display content as the target display content;
determining, in a case where the orientation sensing signal is a second orientation sensing signal, the electronic price tag being in a second orientation and a second orientation display content corresponding to the second orientation, and taking the second orientation display content as the target display content.

11. A content display apparatus based on an electronic price tag display control circuit, comprising:
an acquisition module configured to acquire, in response to a power-on instruction, an orientation sensing signal corresponding to an electronic price tag, wherein different orientation sensing signals correspond to different display contents; and
a display module configured to determine a target display content corresponding to the orientation sensing signal, and present the target display content on the electronic price tag.

12. A computing device, comprising a memory, a processor, and computer instructions stored on the memory and runnable on the processor, wherein the processor, when executing the computer instructions, implements the steps of the method of claim 9.

13. A non-transitory computer-readable storage medium, which stores computer-executable instructions, wherein the computer instructions, when executed by a processor, implement the steps of the method of claim 9.

14. The circuit of claim 2, wherein that the two ends of the orientation sensing end are respectively connected to the bridge rectifier circuit and the electronic price tag, comprises:
an end of the orientation sensing end is connected to a target input end of the bridge rectifier circuit, and the other end of the orientation sensing end is connected to a logic input end of the electronic price tag.

15. The circuit of claim 3, wherein that the two ends of the orientation sensing end are respectively connected to the bridge rectifier circuit and the electronic price tag, comprises:
an end of the orientation sensing end is connected to a target input end of the bridge rectifier circuit, and the other end of the orientation sensing end is connected to a logic input end of the electronic price tag.

16. The computing device of claim 12, wherein the processor, when executing the computer instructions, implements the steps of the method of claim 10.

17. The non-transitory computer-readable storage medium of claim 13, wherein the computer instructions, when executed by a processor, implement the steps of the method of claim 10.
